(19) United States
(12) Patent Application Publication
(10) Pub. No.: US 2011/0029374 A1
(43) Pub. Date: Feb. 3, 2011

(54) DYNAMIC AD SCHEDULING METHOD FOR IMPROVING UTILITY IN INTERACTIVE TV ENVIRONMENT

(76) Inventors: Muralidharan Kodialam, Marlboro, NJ (US); Tirunell Lakshman, Morganville, NJ (US); Sarit Mukherjee, Marlboro, NJ (US); Limin Wang, Plainsboro, NJ (US)

Correspondence Address: HARNESS, DICKEY & PIERCE, P.L.C., P.O. BOX 8910, RESTON, VA, 20195, US

(21) Appl. No.: 12/534,397

(22) Filed: Aug. 3, 2009

(51) Int. Cl. G06Q 30/00; G06Q 10/00

(52) U.S. Cl. 705/14.42; 705/14.43; 705/14.46; 705/14.53; 705/14.61

(57) ABSTRACT

Example embodiments provide scheduling a plurality of ads to be shown to a plurality of viewers of a multimedia network. One example embodiment includes determining target view rates for each of the plurality of ads based on expected revenue associated with each of the plurality of ads, determining, for each of the plurality of ads, a queue value based on a target view rate and an actual view rate associated with the ad, the actual view rate being a number of views of the ad in a previous time slot, and selectively showing ads, from among the plurality of ads, to the plurality of viewers based on the queue values.

### BACKGROUND OF THE INVENTION

1. Field

Example embodiments of the present invention relate generally to methods of scheduling ads in an interactive TV environment.

2. Description of Related Art

TV networks allow users or subscribers to view a wide variety of different types of programs. The large numbers of viewers who watch TV make TV a desirable medium for advertisements, which advertisers use to encourage viewer to buy advertised products. Advertisements are generally more effective when shown to viewers who are interested in the products being advertised. Advertisers have been know to take advantage of this fact by, for example, showing ads for toys during Saturday morning cartoons, or ads for car parts during stock car races. This method requires advertisers to make assumptions about what viewers are watching.

With interactive TV services like IPTV or true2way cable TV, it is possible for a TV service provider to obtain more direct viewing habit information with respect to when and/or what a specific viewer is watching. Further, an interactive TV service provider can use viewer profile information to target ads to specific groups of viewers. Interactive TV service providers can use the increased amount of viewing habit information and the increased ability to target ads to schedule ads in a manner that increases efficiency and an amount of compensation derived from airing the ads.

### SUMMARY OF THE INVENTION

The present invention relates to a method of using viewing habit information to dynamically schedule ads.

In one embodiment, in a method of scheduling a plurality of ads to be shown to a plurality of viewers of a multimedia network, target view rates are determined for each of the plurality of ads based on expected revenue associated with each of the plurality of ads. A queue value of each of the plurality of ads is determined based on the target view rate and a actual view rate of each of the ads, and ads from among the plurality of ads are shown to each of the plurality of viewers based on current queue values of each of the plurality of ads, respectively. The actual view rate is a number of views of the ad in a previous time slot.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1 is a diagram illustrating a portion of an exemplary interactive TV network.

FIG. 2 is a flow chart illustrating an exemplary method of dynamically scheduling ads shown to a plurality of viewers of an interactive TV network.

### DETAILED DESCRIPTION OF EXAMPLE EMBODIMENTS

Various example embodiments of the present invention will now be described more fully with reference to the accompanying drawings in which some example embodiments of the invention are shown.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

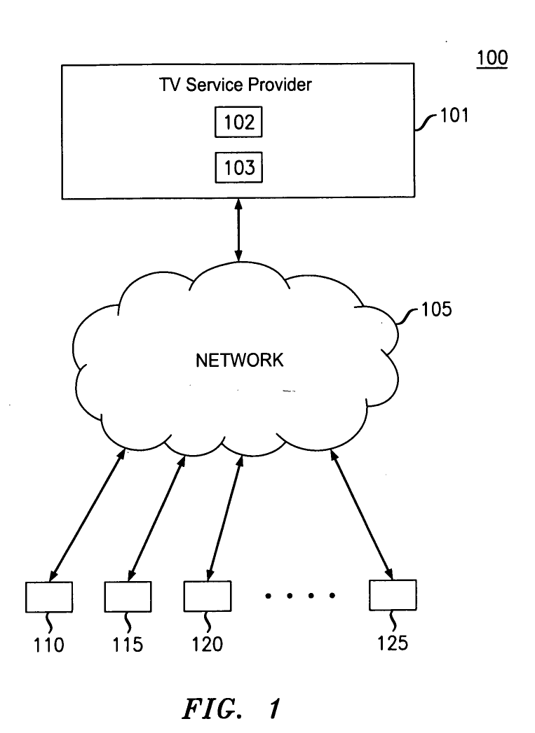

FIG. 1 illustrates a portion of an interactive TV network 100. TV network 100 may include a TV service provider 101, a network 105, and user devices 110˜125. TV service provider 101 is connected to network 105. Network 105 may be in communication with user devices 110˜125. TV service provider 101 may be the operator of interactive TV network 100 and may represent, for example, one or more networks, control circuits, or video hub offices (VHOs) for any of a number of interactive TV services including, for example, internet protocol TV (IPTV) or tru2way cable TV.

TV service provider 101 may have any number of viewers. Viewers may be subscribers to services offered by TV service provider 101.

TV service provider 101 may communicate with viewers via network 105 and user devices 110˜125. Network 105 may be, for example, the internet or a cable network.

User devices 110˜125 may be any type of device which allows TV service provider 101 to send and receive information regarding TV services to and from viewers including, for example, a set top box (STB) for use with a television used by a viewer. For the purpose of simplicity, each of the user devices 110˜125 will be described as corresponding to a single viewer, respectively.

Though, for the purpose of simplicity, FIG. 1 illustrates only four user devices 110˜125, TV network 100 may include any number of user devices. Though, for the purpose of simplicity, user devices 110˜125 are illustrated as being connected to TV service provider 101 via network 105, there may be any number of intermediate devices between TV service provider 101 and network 105 and/or between network 105 and user devices 110˜125.

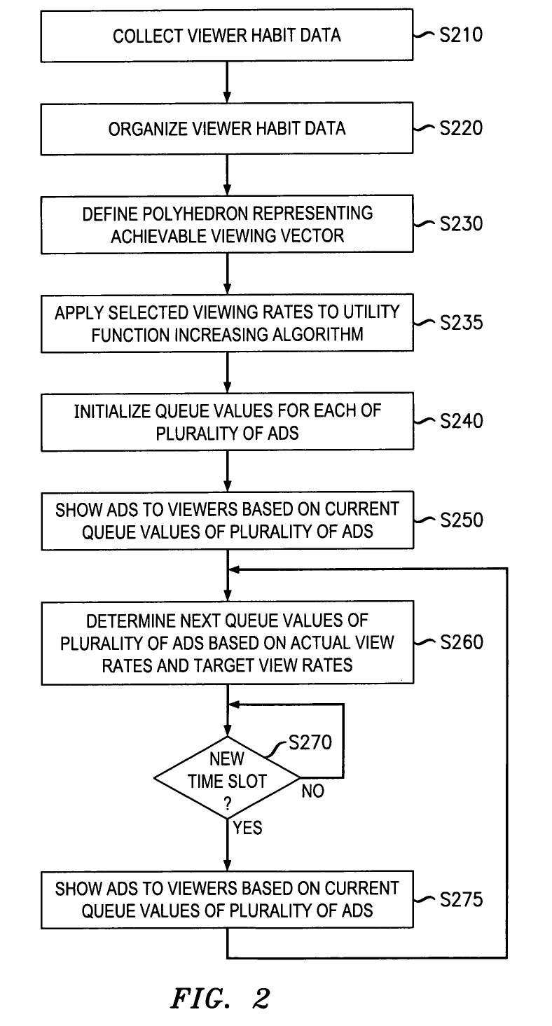

TV service provider 101 includes hardware and/or software capable of receiving, collecting and processing individual viewing habit information from user devices 110˜125. For example, among other things as mentioned above, the TV service provider 101 may include a processor 102, and a memory 103 which may store data and/or programs for use with the processor 102. TV service provider 101 is capable of compiling viewer profiles for each of the viewers associated with user devices 110˜125 in an independent operation. Viewer profiles may include any information regarding a viewer's interests or habits based on, for example, a viewer's web browsing habits, TV watching habits, or online shopping patterns, or information provided from the viewers. Examples of collecting viewer profile information will be discussed below with reference to step S230 in FIG. 2.

The operator of service provider 101 may sell advertisement time to advertisers. The advertisers may choose viewers they are interested in reaching by using the viewer profiles. TV network 100 is configured so that TV service provider 101 may send advertisements to user devices 110˜125 at predetermined or reference time slots. A method of using the viewer habit information to dynamically schedule advertisements will be discussed in further detail below with reference to FIG. 2.

### Overview of Dynamic Ad Scheduling Method

FIG. 2 illustrates a dynamic method of scheduling ads in order to increase or maximize a sum of utility functions with respect to each ad. The utility functions of each ad relate to the amount of compensation received by the operators of TV service provider 101 from each corresponding advertiser and will be discussed further in step S230 below. Accordingly, by maximizing or increasing the sum of utility functions, TV service provider may maximize or increase the compensation derived from scheduling ads.

The method illustrated in FIG. 2 will be discussed with reference to scheduling advertisements corresponding to m advertisers on interactive TV network 100 illustrated in FIG. 1, where m is a natural number greater than 0.

The method illustrated in FIG. 2 will be explained in 3 basic steps: 1) data collection, which will be explained with reference to steps S210-S220, 2) rate optimization, which will be explained with reference to step S230 and 3) dynamic ad scheduling, which will be explained with reference to steps S240-S275.

### Data Collection

In step S210, TV service provider 101 collects viewing habit data from user devices 110˜125. TV service provider 101 is capable of analyzing the viewing patterns of the viewers associated with user device 110˜125 during a time period of, for example, the past three weeks. Specifically, TV service provider 101 is capable of collecting and mining viewers' channel switching events from user device 110˜125 in the form of logs.

In an IPTV environment, viewers may choose which TV data to view by using Internet Group Management Protocol (IGMP) leave and join requests for leaving and joining different multicast groups corresponding to different TV data streams. Accordingly, in an IPTV environment, for example, user devices 110˜125 may be set top boxes (STBs) and, in step S210, TV service provider 101 may collect information regarding join and leave requests from user devices 110˜115.

As another example, in a DTV environment, user devices 110˜125 may again be STBs, and service provider 101 may collect STB specific messages which may contain a current channel request and the timestamp of the channel request from a viewer.

In order to process channel switching messages and form the logs, TV service provider 101 translates channel switching messages into, for example, a canonical form of (viewer_id, action, time, channel_address). In this case, an action can be ‘join’ or ‘leave’, corresponding to an IGMP join or leave message, with reference to a particular channel. TV service provider 101 may gather viewer actions in real time, or aggregate individual logs from user device 110˜125 or any other intermediary boxes in TV network 100.

After viewing habit data is collected in step S210, in step S220, the viewing habit data collected in step S210 is organized in order to facilitate the calculation of probabilities regarding a viewer's future viewing habits.

In step S220, TV service provider 101 organizes the viewing habit data collected in step S210 by considering logs of viewing habit data of a sufficiently large time window, splitting all logs into repeating periods, and quantizing the repeating periods into epochs. Step S220 is discussed in greater detail below.

First, all logs of viewing habit data collected in step S210 are split into repeating time periods. It is assumed that TV programs have apparent cycles, where program schedules often repeat week by week. In step S220, the data logs obtained by service provider 101 in step S210, are split into repeating periods which are used as the time units of “event space”. Each repeating time period may correspond to, for example, a week, and may include, for example 700 epochs. Epochs will be discussed in further detail below. The more repeating periods obtained from the logs, the larger the event space and the more reliable data mined from the log will be. In order to derive meaningful probabilities of viewing behaviors, it is desirable to have sufficient “event space”.

After splitting time into repeating time periods, the relative viewing time of each viewer action can be obtained by taking the difference of the actual time of the viewer action and the nearest beginning boundary of a period. As a result, for the same relative time, there is one point in each period. The more periods obtained, the bigger the potential dataset for viewer habit computations. For example, with week long repeating time periods each including 700 epochs, epochs 1-700 in a first repeating time period may correspond to epochs 1-700 in a second repeating time period, respectively.

Next, time quantization is performed on all repeating time periods of all logs. The time field in each of the logs collected by TV service provider 101 from user devices 110˜125 in step S210 is continuous. However, for practical purposes, providing enhanced services such as targeted advertisements will be discussed with reference to time epochs. In step S220, each time repeating time period is split into epochs. An epoch refers to a short period of time, for example, 1-15 minutes, where either regular TV programs or commercials can be played continuously without any interruption.

Once the viewing habit information is organized, a prediction query engine (PQE) can then be used to answer specific queries regarding various probabilities (conditional or unconditional) of viewer's future viewing habits based on the organized viewing habit information. The PQE may be embodied, for example, in the form of a program stored in memory 103 and executed by processor 102. The probabilities calculated by the PQE can be used to make decisions regarding when to deliver a particular advertisement to one or more of user devices 110˜125.

The process by which the PQE uses the organized viewing habit data to generate probabilities regarding a viewer's future viewing behavior will now be discussed. Once the viewing habit data has been organized, queries regarding a viewer's future viewing behavior can be submitted to the PQE, and the PQE can use the organized viewing habit data to produce probabilities in response to the queries. Depending on the query to the PQE, the PQE finds the viewer state the query is interested in, computes the probability of the required condition in the query, and returns a result for the query. The viewer state can include many factors, such as current relative time, what program the viewer has watched and for how long. The viewer state may represent any pre-existing conditions for a particular viewer at a given time.

For example, the following query: given a viewer having state at time t, what is the probability of a viewer accessing the same channel (thus having the same state s) at time t+Δₜ?, can be handled by first finding in the channel log all occurrences of state s at relative time t among all available periods, denoting the occurrences as N. Then, from among these occurrences, it is determined how many times at relative time t+Δₜ the viewer is accessing the same channel and the number of times is denoted as M. The final answer is M/N.

A more detailed numerical example of the operation of the PQE will now be discussed. Suppose there is a log of viewer A on channel 3 for a moving time window of 10 weeks, the repeating period is a week, and the epoch quantization is 5 minutes. A is now watching channel 3 at the 8:00 pm time epoch on Monday. If, the PQE receives the following query: given A is on channel 3 now, how likely is it that A will still be watching channel 3 at 8:45 pm Monday?, the PQE will operate as follows. First, the PQE searches the log of viewer A and determines A has been watching channel 3 at 8:00 pm on Monday 7 times in the last 10 weeks, which means N=7. Among the 7 occurrences, A has stayed on channel 3 till 8:45 pm for 3 times, meaning M=3. So the conditional probability of A's accessing channel 3 at 8:45 pm is 3/7.

The discussion of the operation of the PQE given above is provided as an example. More complex queries can be constructed and answered by the PQE. The manner in which the probabilities provided by the PQE are used to schedule targeted ads to different viewers will be discussed below with reference to steps S230˜S270.

### Rate Selection

Viewers of TV network 100 may be assigned to different multicast groups. TV data can be streamed to each member of a multicast group simultaneously. With respect to interactive TV network 100, it is assumed that there are no restrictions on the size of the multicast groups. Therefore, the user devices 110˜125 are not coupled and the particular channel that a viewer is tuned into can be ignored with respect to broadcasting ads.

An advertiser j showing ads on interactive TV network 100 can select a subset of viewers advertiser j is interested in reaching, viewer sub-group Sⱼ, and a desired view rate dRⱼ advertiser j is interested in achieving. An advertiser j may use viewer profile information to select the sub-group of viewers Sⱼ. As is stated above with reference to FIG. 1, TV service provider 101 may collect viewer profile information which may include any information regarding a viewer's interests or habits based on, for example, a viewer's web browsing habits, TV watching habits, or online shopping patterns as observed by TV service provider 101. The collected viewer profile information is used to place viewers in interest categories based on the interests of each viewer. Interest groups may include, for example, automobiles, travel, investing, cooking, etc. Interest categories may further include sub-categories. For example, the automobile interest category may include the following sub-categories: auto sales, antique autos, auto maintenance, etc. Examples of collecting and using viewer profile information are discussed below.

As an example of collecting viewer profile information, the operators of TV service provider 101 may provide questionnaires to the viewers using user devices 110˜125. The questionnaires may include questions designed to determine the interests of each viewer. Based on the viewers' answers, each viewer may be categorized into one or more of the interest categories and/or sub-categories. For example, if a particular viewer's questionnaire answers indicate that he viewer is inserted in investment, the viewer is placed in the investment interest category.

As another example of collecting viewer profile information, viewing habit data collected in step S210 can be used to categorize viewers. For example, if, based on the viewing habit data logs, service provider 101 determines a particular viewer spends an amount of time watching shows about fixing cars that exceeds a given threshold, the viewer is placed into the auto maintenance interest sub-category. Further, if service provider 101 determines a particular viewer has watched, in a reference time period, a number of shows about fixing cars that exceeds a reference threshold, the viewer is be placed into the auto maintenance interest sub-category.

Once the viewers are placed or categorized according to interest, each advertiser j can choose viewers to include in sub-group Sⱼ based on the categorization of each viewer. Viewers can each be in more than one category and/or sub-category. For example, if advertiser 1 sells motor oil, advertiser 1 can review the collected viewer profile information, and advertiser 1 can choose to include all viewers determined to be in the auto maintenance interest sub-category in advertiser 1's sub-group, S₁.

Accordingly, For the ads of each advertiser j, a set of viewers to show the ad to, Sⱼ, is chosen based on each viewer's interests, as represented by the viewer profile information, and the subject matter of the ad.

The desired viewing rate dRⱼ is defined as a number of views of an ad of advertiser j that advertiser j wants to achieve per time slot. Each epoch may include one or more time slots. For example, a 15 minute epoch of a weekly repeating time period corresponding to 8:30 PM-8:45 PM on Tuesdays may include four time slots. An ad of an advertiser j is considered to be ‘viewed’ if a user device 110˜125 is on, or ‘tuned in’, during a time slot in which the ad is displayed. It is assumed that only one ad can be shown to each user device 110˜125 in a given time slot.

Because viewer subsets S of the m advertisers may overlap, not all combinations of desired viewing rates are achievable. For example, assume an advertiser 1 and an advertiser 2 share the same sub-group of targeted viewers (S₁=S₂), which includes 10 viewers. As is stated above, a desired view rate dR corresponds to a desired number of views per time slot. Accordingly, in this case, if the desired view rate of advertiser 1, dR₁=7, and if the desired view rate of advertiser 2, dR₂=5, there is no way both advertiser 1 and advertiser 2 can achieve their respective desired view rates because the total number of viewers in S₁ and S₂ that can be reached in a single time slot is only 10, and the sum of desired view rates dR₁ and dR₂, 12, exceeds 10.

To prevent the desired view rates dR of the m advertisers from being allocated in an impossible manner, in step S230, a polyhedron P is constructed that defines the achievable viewing vector space. A potential viewing vector R is defined as the set of desired viewing rates for each advertiser j having an ad scheduled on interactive TV network 100. For example, if advertisers 1 through m have ads scheduled on interactive TV network 100, the potential viewing vector R would be defined as R=(dR₁, dR₂, . . . , dRₘ). However, the achievable viewing vector space should include only those potential viewing vectors R that are possible.

The polyhedron P is defined as follows. A potential viewing vector R=(R₁, R₂, . . . , Rₘ) is achievable using some ad scheduling policy if and only if the viewing vector R lies in the polyhedron P given by

$${\sum }_{j ∈ T} {R}_{j} \leq {⋃}_{j ∈ T} {⋃}_{i ∈ {S}_{j}} {p}_{i} , ∀ T ⊆ \{ 1 , 2 , … , m \}$$

where pᵢ equals the probability that a viewer i is ‘tuned-in’ at a given time slot, Rj is the achievable target rate of advertiser j (discussed below), and m is the total number of advertisers j. Each of the probabilities pᵢ are determined by submitting queries to the PQE, which uses the organized viewing habit data to calculate the probabilities pᵢ in the manner described above with reference to step S220.

In step S230, the TV service provider 101 defines a set of constraints for achievable target view rates Rⱼ, and determines whether the target view rate of the ads of each advertiser j meets the defined constraints based on viewer probabilities pᵢ of viewers in each sub-group of viewers Sⱼ. Specifically, the TV service provider 101 determines whether a potential viewing vector R is achievable, and prevents desired viewing rates included in unachievable viewing vectors R from being scheduled. If the set of desired rates dR of the m advertisers are determined not to be achievable, the desired rates dR will be adjusted until the desired rates form an achievable potential viewing vector R. Rates of each advertiser j that are determined to be achievable will be referred to as target rates Rⱼ. A target rate Rⱼ may be a desired rate dRⱼ that is initially a member of an achievable potential viewing vector R, or a desired rate dRⱼ that was adjusted in order to become a member of an achievable potential viewing vector R.

As is illustrated above, the polyhedron P is constructed by calculating a union of the viewer probabilities pᵢ of each viewer sub-group Sⱼ of each possible subset of the m advertisers having ads on interactive TV network 100.

The sufficiency of the polyhedron P may be shown as follows. The right hand side of the equation is a submodular set function and therefore the polyhedron P is a polymatroid.

The polymatroid status of the polyhedron P in turn implies that the polyhedron has m! extreme points, one corresponding to each ordering of the advertisers j. It can be show that all the extreme points of this polyhedron are achievable, and by the convexity of the polyhedron P, the entire polyhedron P is achievable.

The main implication of the fact that the polyhedron P is a polymatroid is that a greedy algorithm can be used to maximize any concave objective function. The manner in which the aforementioned feature of the polyhedron P is used to maximize utility functions of the target rates R of m advertisers will be discussed below with respect to step S235.

In step S235, service provider 101 uses the polyhedron P constructed in step S230 to maximize the utility functions of the rates Rⱼ of the advertisers j.

Each advertiser j may have an associated utility function ƒⱼ that represents expected revenue associated with an advertiser j based on the compensation an advertiser j is willing to pay the operators of TV service provider 101 for a target rate Rⱼ. Accordingly, the utility function θⱼ defines the relationship between the target rate Rj and the expected revenue associated with the ad of an advertiser j. For example, an advertiser 1 and an advertiser 2 may each have target view rates R₁ and R₂, respectively, of 100 views per time slot. Advertiser 1 may be willing to pay the operators of TV service provider 101 $1.00 each for each of the 100 views per time slot. However, advertiser 2 may be willing to pay the operators of TV service provider 101 $2.00 each for the first 25 views per time slot, and a steadily decreasing amount for the remaining 75 views per time slot. In this case, utility functions ƒ₁ and ƒ₂ of advertisers 1 and 2 will be different.

Assuming the utility function θⱼ(Rⱼ) for an advertiser j is some concave, increasing function of the target view rate Rⱼ, service provider 101 can use the utility functions of each of the advertisers j to achieve the following:

$${max}_{R ∈ p} {\sum }_{j = 1}^{m} {f}_{j} ( {R}_{j} ) ,$$

thus maximizing or increasing the sum of the utility functions of, and total expected revenue from, the m advertisers having ads on interactive TV network 100.

Accordingly, in step S235, target rates R may be adjusted so that the TV service provider 101 selects the target rates R that 1) maximize or increase the sum of the utilities, and expected revenue, associated with the m advertisers, and 2) fall within the achievable viewing vector space defined by the polyhedron P using the following optimization algorithm:

1. Initialize all Rⱼ=0 and free variables F={1, 2, . . . , m}.

2. Compute

$$k = arg {max}_{j ∈ F} {f}_{j} ( {R}_{j} )$$

3. If Rₖ+1ε{P}, set Rₖ←Rₖ+1 and go to Step 2.

4. Else F←F\k and if F≠Ø go to Step 2. If F=Ø then Stop.

For the sake of simplicity, it is assumed that all target rates Rⱼ as well as the right hand side of the polyhedron P are integral.

The manner in which TV service provider 101 uses the target rates R selected in step S235 to schedule the ads of the m advertisers on interactive TV network 100 will be discussed below with reference to steps S240-S270.

### Dynamic Ad Scheduling

Once target rates R are selected for each of the m advertisers, TV service provider 110 implements a four operation dynamic ad scheduling algorithm that uses a queue system to schedule ads. In the dynamic ad scheduling algorithm, each advertiser j is assigned a queue value for each time slot t, Qⱼ(t). Each operation of the dynamic ad scheduling algorithm will now be discussed in greater detail with reference to steps S240˜S275 illustrated in FIG. 2.

In step S240, the queue values Qⱼ(t) of each of the m advertisers is initialized to, for example, a value of ‘0’.

In step S250, ads of the m advertisers are shown to user devices 110˜125 based on the queue values assigned to each advertiser. In particular, at any time slot t the queue values Qⱼ(t) are ordered in decreasing queue value order. For a given user device, the ad that is shown to the user device during the current time slot t is the ad of the advertiser, from among all advertisers in the user device's ad group, that has the highest queue value for the current time slot t.

The ad group of a given user device is defined as the set of advertisers j that include the user device in the viewer sub-group Sⱼ. For example, if user device 110 is included in viewer sub-groups S₂, S₃, S₅ and S₆, then the ad group of user device 110 includes advertisers 2, 3, 5 and 6.

Further, if at time slot t queue values are ordered as follows Q₁(t)≧Q₂(t)≧Q₆(t)≧Q₅(t)≧Q₃(t)≧Q₄(t), then the ad shown to user device 110 at time slot t will be the ad of advertiser 2, because advertiser 2 has the highest queue value out of all the advertisers in user device 110's ad group at time slot t.

Accordingly, in step S260, for each viewer, a set of ads to show to the viewer, the ad group, is determined based on the viewer's interests and the subject matter of each ad, as each ad group is chosen based on viewer sub-groups S, and the ad having the highest queue value from among the ads in the determined set is shown.

In step S260, the queue values Qⱼ(t+1) of the next time slot, t+1, are set for each advertiser j based on the target view rate, Rⱼ, and an actual view rate Vⱼ(t) for time slot t, of each advertiser j. The actual view rate Vⱼ(t) and the queue values Qⱼ(t) are determined according to the following expressions:

$${V}_{1} ( t ) = \vert {A}_{1} ( t ) \vert , {V}_{j} ( t ) = \vert {A}_{j} ( t ) \vert - \vert {⋃}_{k = 1}^{j - 1} {A}_{k} ( t ) \vert , for j = 2 , 3 , … , m . \\ {Q}_{j} ( t + 1 ) ← max \{ 0 , {Q}_{j} ( t ) + {R}_{j} - {V}_{j} ( t ) \} for j = 1 , 2 , … , m$$

The set of viewers that are viewing is known by TV service provider 101 at the beginning of any time slot. Aⱼ(t) represents the number of user devices 110˜125 that are members of viewer sub-group Sⱼ, and are on, or ‘tuned-in’ at time slot t. Vⱼ(t) represents the number of user devices 110˜125 that are members of viewer sub-group Sⱼ, and are actually viewing the ad of advertiser j at time slot t. For example, if 25 members of viewer sub-group S₂ are viewing at time slot t₃, but only 15 members of viewer sub-group S₂ are actually viewing the ad of advertiser 2, A₂(t₃)=25, and V₂(t₃)=15. Specifically, in step S260, the queue value of each advertiser j is adjusted based on a comparison between the corresponding target view rate, Rⱼ, and the corresponding actual view rate Vⱼ(t) for time slot t.

As shown by the above expressions, queue values for advertisers who received a number of actual views lower that the target view rate Rⱼ at time slot t experience an increase in value for time slot t+1, and queue values for advertisers who received a number of actual views higher than the target view rate Rⱼ at time slot t experience a decrease in value for time slot t+1, with a minimum level of 0.

The increase and decrease in queue values is proportional to the magnitude of the difference between the target view rate, Rⱼ, and the actual view rate Vⱼ(t) for time slot t. By altering the queue values, the scheduling algorithm changes the amount of views each advertiser j is likely to receive in the next time slot, t+1.

In step S270, once the time slot has ended, the scheduling algorithm proceeds to step S275.

In step S275, the ads are shown in the same manner described above with respect to step S250, based on the queue values determined in step S260, which are now current queue values. Namely, ads of the m advertisers are shown to user devices 110˜125 based on the queue values assigned to each advertiser in step S260. For each of the user devices 110˜125 the ad that is shown to the user device during the current time slot t is the ad of the advertiser, from among all advertisers in the user device's ad group, that has the highest queue value for the current time slot t. Once the ads are shown, the scheduling algorithm returns to step S260, operation 3 is executed again, and the queue values for the next time slot are calculated again.

In this manner, with multiple iterations of steps S260˜S275 over multiple time slots t, the scheduling algorithm can provide an overall average view rate that is at or close to target view rate Rⱼ for each advertiser j. Further, because the dynamic scheduling algorithm uses target view rates Rⱼ which were chosen in manner that increases or maximizes the utility functions of the m advertisers in step S235, the dynamic ad scheduling algorithm schedules the ads of the m advertisers in a manner that increases or maximizes the sum of expected revenue associated with the m advertisers.

Thus, according to the method provided above, TV service provider 101 may schedule ads in a manner that maximizes or increases a sum of utilities with respect to each advertiser thus increasing or maximizing expected revenue received as a result of the ads aired.

All of the functions described above with respect to the method are readily carried out by special or general purpose digital information processing devices acting under appropriate instructions embodied, e.g., in software, firmware, or hardware programming. For example, modules implementing the functionality can be implemented as an ASIC (Application Specific Integrated Circuit) constructed with semiconductor technology and may also be implemented with FPGA (Field Programmable Gate Arrays) or any other hardware blocks.

The invention being thus described, it will be obvious that the same may be varied in many ways. Such variations are not to be regarded as a departure from the invention, and all such modifications are intended to be included within the scope of the invention.

What is claimed:

1. A method of scheduling a plurality of ads to be shown to a plurality of viewers of a multimedia network, the method comprising:
determining target view rates for each of the plurality of ads based on expected revenue associated with each of the plurality of ads;
determining, for each of the plurality of ads, a queue value based on a target view rate and an actual view rate associated with the ad, the actual view rate being a number of views of the ad in a previous time slot; and
selectively showing ads, from among the plurality of ads, to the plurality of viewers based on the queue values.

2. The method of claim 1, wherein the determining target view rates step includes determining the target view rates such that a sum of the expected revenue for each of the plurality of ads is maximized.

3. The method of claim 1, wherein the determining a queue value step comprises:
increasing queue values of each ad, from among the plurality of ads, for which the associated actual view rate is lower than the associated target view rate; and
decreasing queue values of each ad, from among the plurality of ads, for which the associated actual view rate is higher than the associated target view rate.

4. The method of claim 3, wherein determining the next queue value of each of the plurality of ads includes determining a sum of the current queue value and the desired rate, and subtracting from the determined sum the actual view rate.

5. The method of claim 1, further comprising:
determining a set of ads, from among the plurality of ads, to show to each viewer based on the interests of the viewer and the subject matter of each ad; and
for each of the plurality of viewers, showing the ad having the highest queue value from among the ads in the determined set.

6. The method of claim 5, wherein the showing the ad step includes showing to each of the plurality of viewers, one ad, from among the plurality of ads, per time slot.

7. The method of claim 1, wherein the determining the target view rates step comprises:
determining, for each ad, a set of viewers, from among the plurality of viewers, to show the ad to based on each viewer's interests and the subject matter the ad;
determining whether a desired view rate of each ad meets defined constraints based on probabilities of viewers in each determined set of viewers seeing the ad; and
changing the desired view rates based on the determining whether a desired view rate meets defined constraints step to produce the target view rates.

8. The method of claim 7, wherein
the defined constraints are defined by a reference polyhedron which is determined by calculating a union of the viewer probabilities of each determined set of viewers of each subset of the plurality of ads, and
the achievable sets of target view rates are defined as sets of target view rates that lie within the reference polyhedron.

9. The method of claim 7, wherein the changing the desired view rates step includes changing the desired view rates to produce the target view rates such that such that a sum of the expected revenue for each of the plurality of ads is maximized.

10. The method of claim 7 further comprising:
collecting viewing habit data for each of the plurality of viewers by forming logs of channel switching requests received from the viewer; and
organizing the collected viewing habit data by splitting the logs into repeating periods,
wherein the viewer probabilities are determined based on the organized viewing habit data of each viewer.

11. The method of claim 10, wherein the channel switching requests are one of Internet group management protocol (IGMP) join and leave requests.

12. The method of claim 1, wherein the determining target view rates step includes
selecting the target view rates such that a sum of utilities of the plurality of ads is increased, the sum of utilities being a sum of a set of utility functions corresponding to each of the plurality of ads, respectively, each utility function defining a relationship between the target viewing rate and expected revenue for each corresponding ad.

13. The method of claim 12, wherein the determining target view rates step includes selecting the target view rates such that the sum of utilities of the plurality of ads is maximized.

14. The method of claim 1, wherein the multimedia network is one of an Internet protocol television (IPTV) network, a cable television network, and a true2way television network.
